(19) United States
(12) Patent Application Publication
(10) Pub. No.: US 2026/0138682 A1
(43) Pub. Date: May 21, 2026

(54) COUPLING STRUCTURE FOR VEHICLE

(71) Applicants: HYUNDAI MOTOR COMPANY, Seoul (KR); KIA CORPORATION, Seoul (KR)

(72) Inventors: Yuri Myoung, Hwaseong-si (KR); Jeong Chul Jung, Hwaseong-si (KR); Min Young Lee, Hwaseong-si (KR)

(73) Assignees: HYUNDAI MOTOR COMPANY, Seoul (KR); KIA CORPORATION, Seoul (KR)

(21) Appl. No.: 19/271,749

(22) Filed: Jul. 16, 2025

(30) Foreign Application Priority Data
Nov. 20, 2024 (KR) 10-2024-0166276

(51) Int. Cl. B62D 27/06; B62D 63/02

(52) U.S. Cl. CPC B62D 27/06; B62D 63/025

(57) ABSTRACT

The present disclosure provides a coupling structure for a vehicle, which includes an under body configured to constitute a drive module, and an upper body coupled to an upper end of the under body and configured to constitute a space module. The coupling structure includes an under body fastening part provided in the under body and disposed to be coupled to the upper body by a magnetic force, and an upper body fastening part provided in the upper body and disposed to be coupled to or uncoupled from the under body fastening part by applying or eliminating the magnetic force.

### CROSS-REFERENCE TO RELATED APPLICATION(S)

This application claims priority to and the benefit of Korean Patent Application No. 10-2024-0166276 filed with the Korean Intellectual Property Office on Nov. 20, 2024, the entire contents of which are incorporated herein by reference.

### TECHNICAL FIELD

The present disclosure relates to a coupling structure for a vehicle. The coupling structure is capable of being attached to or detached from an upper body of an unmanned delivery vehicle to couple the upper body and an under body.

### BACKGROUND

Recently, future mobility visions with new concepts for implementing human-oriented dynamic future cities have been introduced in vehicle industries. One of the future mobility solutions is a purpose-built vehicle (PBV) as a purpose-based mobility vehicle.

Examples of the PBV may include an environmentally-friendly movable vehicle based on an electric vehicle (EV). The PBVs may provide various customized services to users while the PBVs move from starting points to destinations in an unmanned or manned autonomous driving manner.

The PBV may include a cab-type drive module equipped with a drive device and capable of autonomously traveling, and a space module coupled to the drive module and configured to be used for cargo, passengers, home office, or the like.

The drive module and the space module may each include an under body, and an upper body coupled to an upper portion of the under body and configured to be movable together with the under body by driving power from the under body. The under body and the upper body may have magnets provided at positions corresponding to each other so that the under body and the upper body are coupled to or separated from each other by applying or eliminating a magnetic force. When the magnetic force is eliminated, the under body may travel singly.

A lifting magnet, such as an electromagnet, is applied as the magnet used to attach or detach the under body and the upper body. The electromagnet presents a risk that the magnet may be separated by an external force. Further, the electromagnet may degrade the aesthetic appearance of the vehicle because of a complicated multi-step attachment/detachment process and a protruding magnetic force on/off switch. In addition, because an electric current is continuously applied to maintain the magnetic force of the electromagnet, a large loss of energy occurs. Further, in a case that the vehicle is turned off when using an electromagnet, a loss of a magnetic force may make it difficult to maintain a fastening force between the under body and the upper body.

### SUMMARY

The present disclosure provides a coupling structure for a vehicle (e.g., that may be simplified) by applying a permanent magnet to attach or detach a drive module and a space module of a PBV vehicle, reduce the amount of energy used, and improve fastening durability.

An embodiment of the present disclosure provides a coupling structure for a vehicle, which includes an under body configured to constitute a drive module, and an upper body coupled to an upper end of the under body and configured to constitute a space module. The coupling structure includes an under body fastening part (e.g., fastener) provided in the under body and disposed to be coupled to the upper body by a magnetic force, and an upper body fastening part (e.g., fastener) provided in the upper body and disposed to be coupled to or uncoupled from the under body fastening part by applying or eliminating the magnetic force.

The upper body fastening part may include an upper cover, an upper magnet disposed below the upper cover, a lower cover disposed below the upper magnet and coupled to the upper cover, and a center magnet disposed below the upper magnet, configured to be moved to be inserted into or withdrawn from the inside of the lower cover, and having a hollow portion formed at a center thereof.

The upper body fastening part may further include a spring provided on a lateral portion of the lower cover, provided at an end of the center magnet, and configured to provide an elastic force when the center magnet moves.

The upper magnet may include a plurality of bar magnets arranged in parallel in a longitudinal direction of the vehicle.

A magnet column may be inserted into the hollow portion of the center magnet from the outside of the lower cover, the magnet column may allow the center magnet to be withdrawn outward from the inside of the lower cover, and the spring may be compressed.

When the magnet column is inserted into the hollow portion of the center magnet, an attractive force applied by a magnetic force may be lost between the under body fastening part and the upper body fastening part.

When the magnet column is withdrawn from the hollow portion of the center magnet, the center magnet may be inserted into the lower cover by an elastic force of the spring, and an attractive force may be applied between the under body fastening part and the upper body fastening part by a magnetic force.

The under body fastening part may include a permanent magnet having a plate shape corresponding to a shape of a lower surface of the lower cover and coupled to the lower cover.

A plurality of fastening protrusions may be provided on the lower surface of the lower cover and protrude to the outside of the lower cover.

A plurality of fastening grooves may be provided in an upper surface of the under body fastening part and coupled to the plurality of fastening protrusions.

The under body fastening parts and the upper body fastening parts may be provided at four corner portions of the under body and four corner portions of the upper body and provided at positions corresponding to one another, and the magnet columns may be coupled to or uncoupled from the upper body fastening parts by being moved by a jig disposed above the under body and the upper body.

The jig may include a pair of jig fixing parts, and extension columns extending from the jig fixing parts and configured to move in an upward/downward direction, and the magnet columns may be respectively provided at lower ends of the extension columns and have shapes protruding toward the upper body fastening parts.

The jig fixing part may be installed to be moved along a jig movement rail disposed in a shape extending above the under body and the upper body.

A distance measurement sensor may be provided on the jig fixing part and configured to measure a distance between the jig fixing part and the corner portion of the vehicle or a distance between the jig fixing part and a ground surface.

The extension column may be moved downward to allow the magnet column to be inserted into the hollow portion of the center magnet, and a magnetic force between the under body fastening part and the upper body fastening part may be eliminated.

In a state in which the magnet column is inserted into the hollow portion of the center magnet, the extension column may be moved upward, and the jig fixing part may be moved along the jig movement rail, such that the upper body is moved to a location above another charged under body.

After the extension column is moved downward and the upper body is seated on another under body, the jig fixing part may be moved along the jig movement rail and allows the magnet column to be withdrawn from the hollow portion of the center magnet, such that a process of swapping the under body is completed.

According to the example embodiment of the present disclosure, the process of lifting the upper body by using the magnets is applied to eliminate the fastening force between the upper body and the under body of the vehicle on the body swap station for an unmanned delivery vehicle, such that the process of swapping the under body may be quickly and conveniently performed.

In addition, it is possible to reduce noise and provide (e.g., ensure) durability (robustness) during the fastening process in comparison to mechanically fastening the upper body and the under body.

In addition, it is possible to reduce the use of electric power by using magnetization and demagnetization made by the movement of the permanent magnet as compared to using an electromagnet.

### BRIEF DESCRIPTION OF THE DRAWINGS

FIG. 1 is a view illustrating a state before an upper body and an under body are coupled in a coupling structure for a vehicle according to an example embodiment of the present disclosure.

FIG. 2 is a view illustrating a state after the upper body and the under body are coupled in the coupling structure for a vehicle according to the example embodiment of the present disclosure.

FIG. 3 is a view illustrating an upper body fastening part provided in the upper body in the coupling structure for a vehicle according to the example embodiment of the present disclosure.

FIG. 4 is a view illustrating an under body fastening part provided in the under body in the coupling structure for a vehicle according to the example embodiment of the present disclosure.

FIG. 5 is a view illustrating a state in which the upper body fastening part and the under body fastening part are coupled in the coupling structure for a vehicle according to the example embodiment of the present disclosure.

FIG. 6 is a view illustrating the upper body fastening part in the coupling structure for a vehicle according to the example embodiment of the present disclosure.

FIG. 7 is a view illustrating fastening protrusions provided on the upper body fastening part in the coupling structure for a vehicle according to the example embodiment of the present disclosure.

FIG. 8 is a view illustrating fastening grooves provided in the under body fastening part in the coupling structure for a vehicle according to the example embodiment of the present disclosure.

FIG. 9 is a view illustrating a state in which an attractive force is applied between the upper body fastening part and the under body fastening part by magnetism in the coupling structure for a vehicle according to the example embodiment of the present disclosure.

FIG. 10 is a view illustrating a state in which a magnet column is inserted into a center magnet of the upper body fastening part in the coupling structure for a vehicle according to the example embodiment of the present disclosure.

FIG. 11 is a view illustrating a state in which an attractive force applied by magnetism is eliminated between the upper body fastening part and the under body fastening part in the coupling structure for a vehicle according to the example embodiment of the present disclosure.

FIG. 12 is a view illustrating a state in which the vehicle is on standby for a swap on a body swap station according to the example embodiment of the present disclosure.

FIG. 13 is a view illustrating a state in which the magnet column of a jig is inserted into the center magnet of the upper body fastening part to perform a vehicle swap on the body swap station according to the example embodiment of the present disclosure.

FIG. 14 is a view illustrating a state in which the upper body is separated from the under body to perform the vehicle swap on the body swap station according to the example embodiment of the present disclosure.

FIG. 15 is a view illustrating a state in which the upper body is moved to a location above another under body to perform the vehicle swap on the body swap station according to the example embodiment of the present disclosure.

FIG. 16 is a view illustrating a state in which the upper body is coupled to another under body to perform the vehicle swap on the body swap station according to the example embodiment of the present disclosure.

FIG. 17 is a view illustrating a state in which the vehicle swap is completed and the magnet column of the jig is withdrawn from the center magnet of the upper body fastening part on the body swap station according to the example embodiment of the present disclosure.

### DETAILED DESCRIPTION

Hereinafter, embodiments of the present disclosure will be described in detail with reference to the accompanying drawings so those with ordinary skill in the art to which the present disclosure pertains may carry out the example embodiments. The present disclosure may be implemented in various different ways and is not limited to the example embodiments described herein.

In addition, the constituent elements having the same configurations in several embodiments may be assigned with the same reference numerals and may be described in the example embodiment, and the constituent elements, which are different from the constituent elements according to the representative embodiment, may be described in other embodiments.

The drawings are schematic and are not illustrated based on actual scales. Relative dimensions and proportions of parts illustrated in the drawings may be exaggerated or reduced in size for clarity and convenience in the drawings, and any dimension is illustrative but not restrictive. Further, the same reference numerals designate the same structures, elements or components illustrated in two or more drawings in order to exhibit the same or similar characteristics. When one component is described as being positioned “above” or “on” another component, one component can be positioned “directly on” another component, and one component can also be positioned on another component with other components interposed therebetween.

The present disclosure illustrates an example embodiment of the present disclosure. As a result, various modifications of the drawings are expected. Therefore, the example embodiments are not limited to specific forms in regions illustrated in the drawings, and for example, may include modifications of forms by the manufacture thereof.

Hereinafter, a coupling structure for a vehicle according to an example embodiment of the present disclosure will be described in detail with reference to the accompanying drawings.

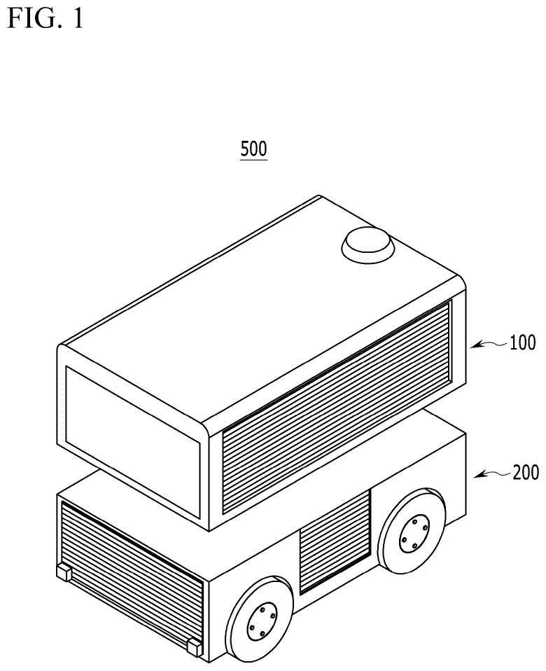

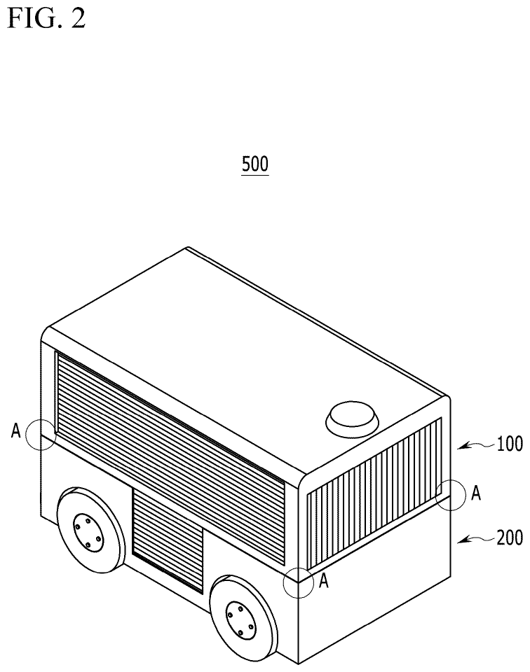

FIG. 1 is a view illustrating a state before an upper body and an under body are coupled in a coupling structure for a vehicle according to an embodiment of the present disclosure, and FIG. 2 is a view illustrating a state after the upper body and the under body are coupled in the coupling structure for a vehicle according to the example embodiment of the present disclosure.

With reference to FIGS. 1 and 2, a vehicle 500 may be a PBV including a drive module, and a space module coupled to an upper portion of the drive module. The drive module adopts a drive device and may perform autonomous driving. The space module may be used for cargo, passengers, home office, or the like. The drive module and the space module are fastened to each other in an upward/downward direction. In an example embodiment, (e.g., only) the drive module may travel when the drive module and the space module are separated.

In the example embodiment of the present disclosure, an under body 200 may constitute the drive module, and an upper body 100 may constitute the space module. The under body 200 and the upper body 100 may (e.g., each) be formed in a rectangular parallelepiped shape and coupled at four corners (e.g., A) thereof.

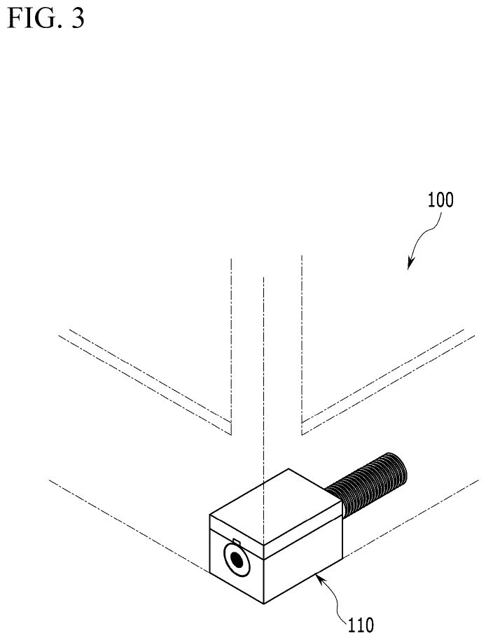

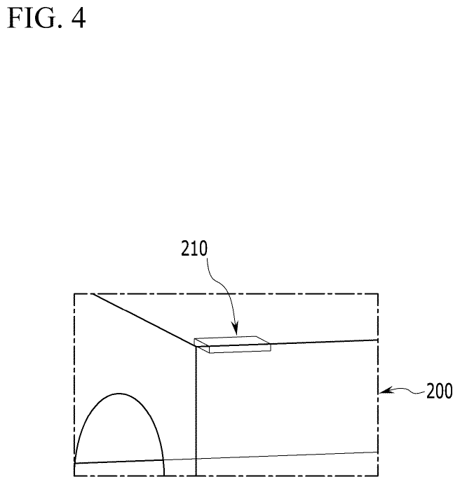

FIG. 3 is a view illustrating an upper body fastening part provided in the upper body in the coupling structure for a vehicle according to the example embodiment of the present disclosure, and FIG. 4 is a view illustrating an under body fastening part provided in the under body in the coupling structure for a vehicle according to the example embodiment of the present disclosure.

With reference to FIGS. 3 and 4, the coupling structure for the vehicle 500 according to the example embodiment of the present disclosure includes under body fastening parts (e.g., fastener) 210 and upper body fastening parts (e.g., fastener) 110. As illustrated in FIG. 4, the under body fastening part 210 may be provided in the under body 200 and disposed to be coupled to the upper body 100 by a magnetic force. The under body fastening parts 210 may be respectively provided at four corners of the under body 200 that faces the upper body 100.

In addition, as illustrated in FIG. 3, the upper body fastening part 110 may be provided in the upper body 100 and disposed to be coupled to or uncoupled from the under body fastening part 210 by applying or eliminating a magnetic force. The upper body fastening parts 110 may be provided at four corners of the upper body 100 that faces the under body 200.

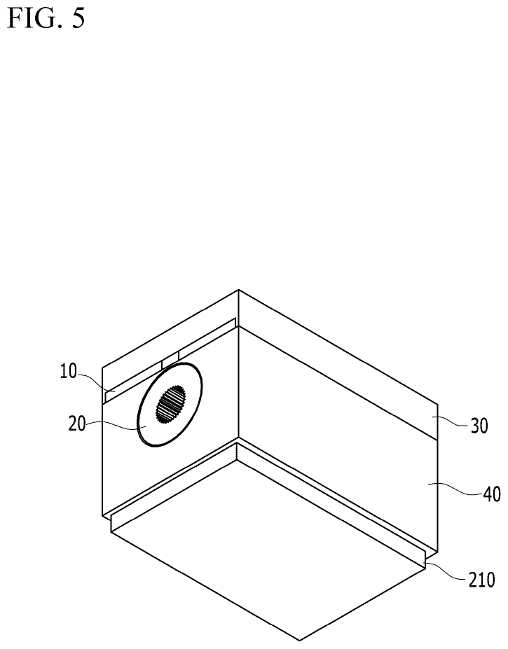

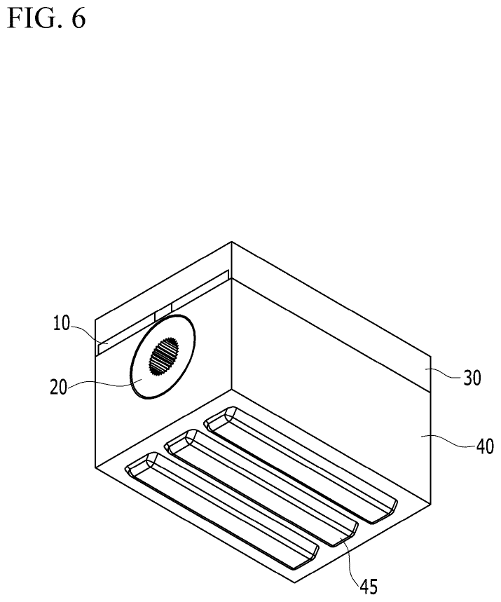

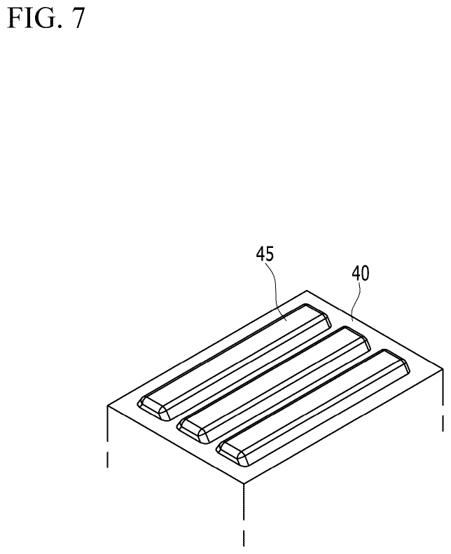

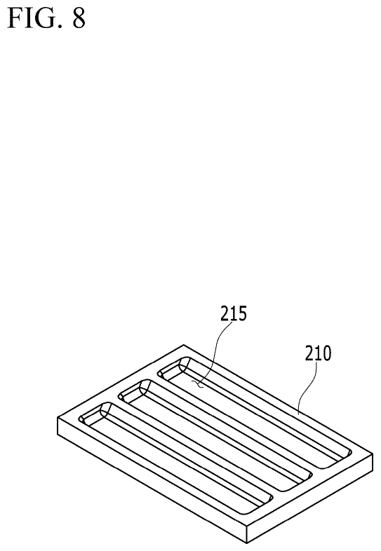

FIG. 5 is a view illustrating a state in which the upper body fastening part and the under body fastening part are coupled in the coupling structure for a vehicle according to the example embodiment of the present disclosure, FIG. 6 is a view illustrating the upper body fastening part in the coupling structure for a vehicle according to the example embodiment of the present disclosure, FIG. 7 is a view illustrating fastening protrusions provided on the upper body fastening part in the coupling structure for a vehicle according to the example embodiment of the present disclosure, and FIG. 8 is a view illustrating fastening grooves provided in the under body fastening part in the coupling structure for a vehicle according to the example embodiment of the present disclosure.

When the under body 200 and the upper body 100 are coupled, as illustrated in FIG. 5, a lower surface of the under body fastening part 210 may be tightly attached and coupled to an upper surface of the upper body fastening part 110 by the magnetic force. The under body fastening part 210 and the upper body fastening part 110 may be formed in rectangular parallelepiped shapes (e.g., corresponding to each other).

The upper body fastening part 110 includes an upper cover 30, a lower cover 40, an upper magnet 10 disposed between the upper cover 30 and the lower cover 40, and a center magnet 20 configured to be moved in the lower cover 40 while being inserted or withdrawn.

The upper magnet 10 may include a plurality of bar magnets arranged in parallel in a longitudinal direction of the vehicle 500, and the center magnet 20 may be disposed below the upper magnet 10 and have a hollow portion formed at a center thereof.

The center magnet 20 may be disposed in a shape extending in a leftward/rightward direction of the vehicle 500 and moved in the lower cover 40 in the leftward/rightward direction of the vehicle 500. A magnet column 330 may be inserted into the hollow portion of the center magnet 20 from the outside of the lower cover 40. When the magnet column 330 is inserted into the hollow portion of the center magnet 20, the magnet column 330 and the center magnet 20 may be moved to be exposed to the outside of the lower cover 40 in the state in which the magnet column 330 is inserted into the hollow portion of the center magnet 20.

The under body fastening part 210 may include a permanent magnet having a plate shape corresponding to a shape of a lower surface of the lower cover 40 and coupled to the lower cover 40.

As illustrated in FIGS. 6 and 7, a plurality of fastening protrusions 45 may be provided on the lower surface of the lower cover 40 and protrude toward the outside of the lower cover 40. In addition, as illustrated in FIG. 8, a plurality of fastening grooves 215 may be provided on an upper surface of the under body fastening part 210 and coupled to the plurality of fastening protrusions 45. The plurality of fastening protrusions 45 and the plurality of fastening grooves 215 may be provided in shapes extending in the leftward/rightward direction of the vehicle 500.

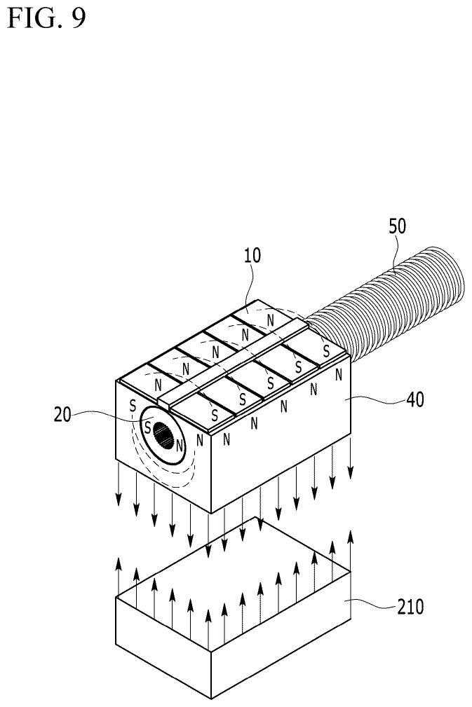

FIG. 9 is a view illustrating a state in which an attractive force is applied between the upper body fastening part and the under body fastening part by magnetism in the coupling structure for a vehicle according to the example embodiment of the present disclosure.

With reference to FIG. 9, the upper magnet 10 may be disposed on an upper portion of the lower cover 40 and include the plurality of bar magnets arranged in parallel in the longitudinal direction of the vehicle 500. The plurality of bar magnets may be disposed in parallel so as to have the same polarity direction, and the lower cover 40 and the center magnet 20 may be disposed below the upper magnet 10 so that polarities of the lower cover 40 and the center magnet 20 are opposite and adjacent to the polarities of the upper magnet 10. With this arrangement, a magnetic force is generated outward toward a lower side of the lower cover 40 by interactions between the magnets, and the magnetic force generates a fastening force with the under body fastening part 210. When the upper body 100 and the under body 200 are fastened, the fastening force is maintained as an attractive force is applied between the upper body fastening part 110 and the under body fastening part 210 in the state in which the center magnet 20 is inserted into the lower cover 40.

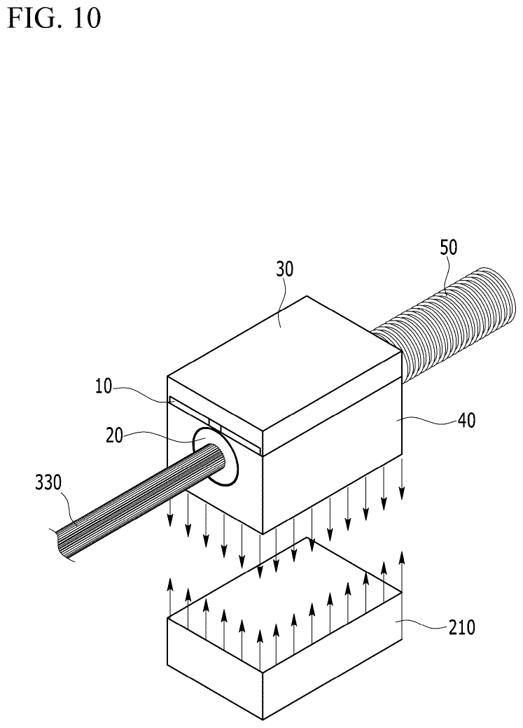

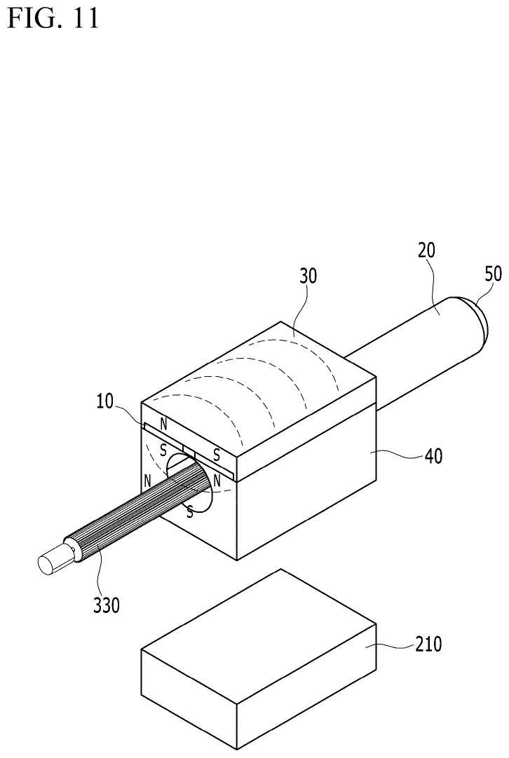

FIG. 10 is a view illustrating a state in which the magnet column is inserted into the center magnet of the upper body fastening part in the coupling structure for a vehicle according to the example embodiment of the present disclosure, and FIG. 11 is a view illustrating a state in which an attractive force applied by magnetism is eliminated between the upper body fastening part and the under body fastening part in the coupling structure for a vehicle according to the example embodiment of the present disclosure.

As illustrated in FIGS. 10 and 11, the magnet column 330 may be inserted into the hollow portion of the center magnet 20 from the outside of the lower cover 40. The magnet column 330 allows the center magnet 20 to be withdrawn outward from the inside of the lower cover 40. The upper body fastening part 110 may further include a spring 50 provided on a lateral portion of the lower cover 40, provided at an end of the center magnet 20, and configured to provide an elastic force when the center magnet 20 moves. The spring 50 is compressed when the center magnet 20 is withdrawn outward from the inside of the lower cover 40.

In this case, because the center magnet 20 is separated from the upper body fastening part 110, the interaction between the magnets generates a magnetic force (e.g., only) between the upper magnet 10 and the lower cover 40, and the magnetic force directed toward the lower side of the lower cover 40 is lost. Therefore, the attractive force may be lost between the upper body fastening part 110 and the under body fastening part 210, and the upper body 100 and the under body 200 may be unfastened.

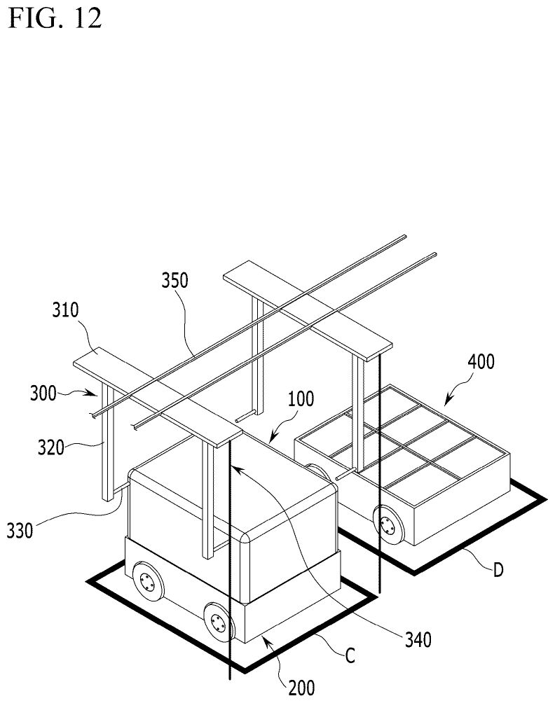

FIG. 12 is a view illustrating a state in which the vehicle is on standby for a swap on a body swap station according to the example embodiment of the present disclosure.

With reference to FIG. 12, in order to swap the under body 200, the vehicle 500 arrives at position (e.g., zone) ‘C’ on the body swap station, and a jig 300 is moved to a location above the vehicle 500 and positioned.

The jig 300 includes a pair of jig fixing parts 310, and extension columns 320 extending from the jig fixing parts 310 and configured to move in the upward/downward direction. The magnet columns 330 are respectively provided at lower ends of the extension columns 320 and have shapes protruding toward the upper body fastening part 110.

The pair of jig fixing parts 310 may be respectively disposed above lateral sides of the vehicle 500 and installed to be moved along jig movement rails 350 disposed above the under body 200 and the upper body 100 and having shapes extending in a transverse direction of the vehicle 500. The jig movement rails 350 may be provided as a pair of jig movement rails 350 disposed and extending in parallel with each other.

A distance measurement sensor 340 may be provided on the jig fixing part 310 and configured to measure a distance between the jig fixing part 310 and a corner portion of the vehicle 500 or a distance between the jig fixing part 310 and a ground surface. The distance measurement sensor 340 may measure the distance between the jig fixing part 310 and the corner portion of the vehicle 500 or the distance between the jig fixing part 310 and the ground surface and allow the jig fixing part 310 and the extension column 320 to move (e.g., precisely).

In a state in which the vehicle 500 is on standby for a swap, the jig fixing parts 310 move along the jig movement rails 350 to allow the extension columns 320 to be positioned above the corner portions of the vehicle 500 and allow another under body 400, which has been completely charged, to be positioned in zone ‘D’.

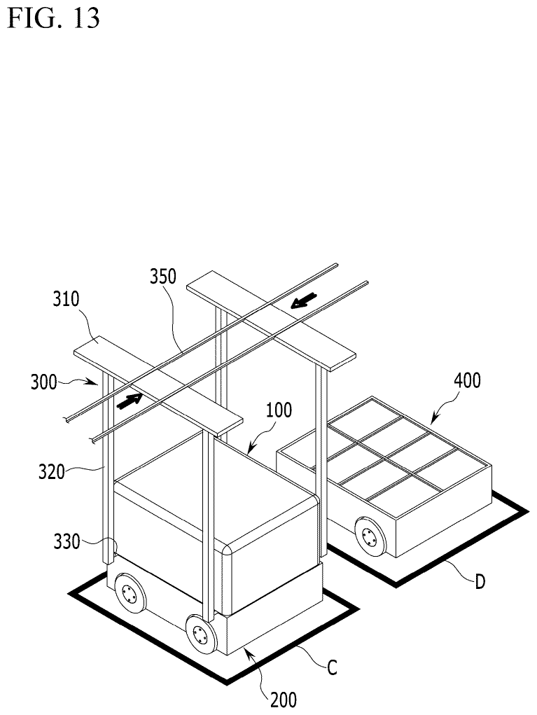

FIG. 13 is a view illustrating a state in which the magnet column of the jig is inserted into the center magnet of the upper body fastening part to perform a vehicle swap on the body swap station according to the example embodiment of the present disclosure.

With reference to FIG. 13, when the swap of the vehicle 500 starts, the pair of jig fixing parts 310 are moved toward the vehicle 500 along the jig movement rails 350, and the magnet columns 330 provided at the lower ends of the extension columns 320 are moved downward so that the extension columns 320 are positioned on the lateral portions of the upper body fastening parts 110. In addition, the jig fixing parts 310 are further moved so that the magnet columns 330 are inserted into the hollow portions of the center magnets 20. In this case, the center magnet 20 is withdrawn from the lower cover 40 of the upper body fastening part 110, such that the attractive force between the upper body fastening part 110 and the under body fastening part 210 is eliminated.

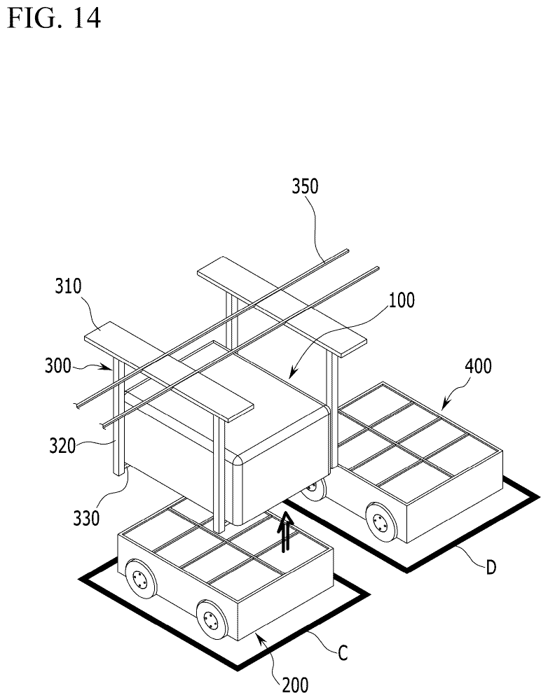

FIG. 14 is a view illustrating a state in which the upper body is separated from the under body to perform the vehicle swap on the body swap station according to the example embodiment of the present disclosure.

With reference to FIG. 14, in the state in which the attractive forces between the upper body fastening parts 110 and the under body fastening parts 210 are eliminated and the magnet columns 330 of the jig 300 are fastened to the upper body fastening parts 110, the extension columns 320 of the jig 300 are moved upward together with the upper body 100, such that the upper body 100 and the under body 200 are separated.

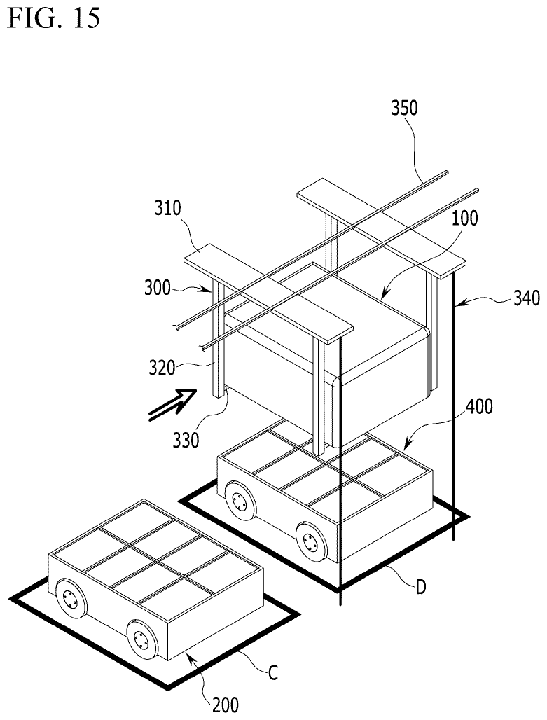

FIG. 15 is a view illustrating a state in which the upper body is moved to a location above another under body to perform the vehicle swap on the body swap station according to the example embodiment of the present disclosure.

With reference to FIG. 15, in the state in which the upper body 100 and the under body 200 are separated, the jig fixing parts 310 are moved together with the upper body 100 along the jig movement rails 350 to a location above another under body 400 present in zone ‘D’.

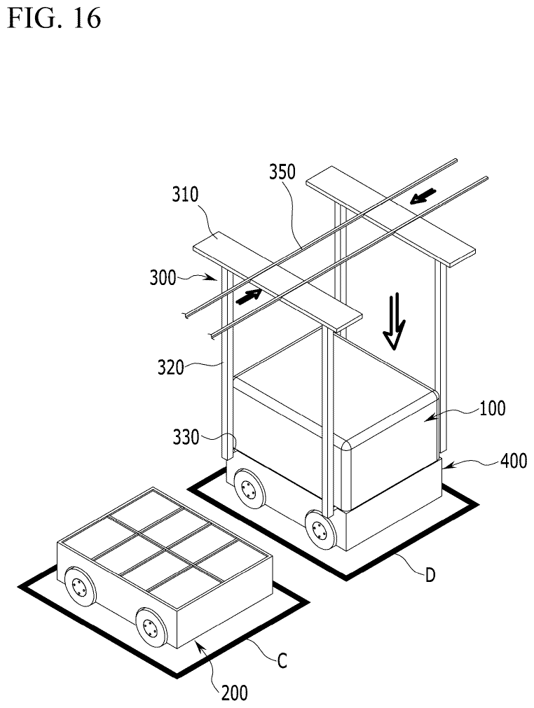

FIG. 16 is a view illustrating a state in which the upper body is coupled to another under body to perform the vehicle swap on the body swap station according to the example embodiment of the present disclosure.

With reference to FIG. 16, the extension columns 320 of the jig 300 are moved downward to allow the upper body 100 to be seated on the upper portion of another under body 400.

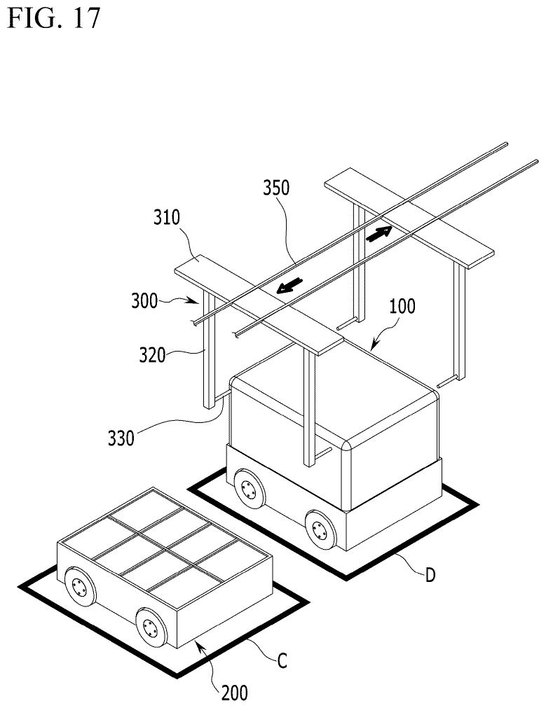

FIG. 17 is a view illustrating a state in which the vehicle swap is completed and the magnet column of the jig is withdrawn from the center magnet of the upper body fastening part on the body swap station according to the example embodiment of the present disclosure.

With reference to FIG. 17, after the upper body 100 is seated on the upper portion of another under body 400, the pair of jig fixing parts 310 are moved away from the vehicle 500 along the jig movement rails 350, and the magnet columns 330 provided at the lower ends of the extension columns 320 are withdrawn from the hollow portions of the center magnets 20. In this case, the center magnets 20 are inserted into the lower covers 40 of the upper body fastening parts 110 by the elastic forces of the springs, and the attractive forces are provided between the upper body fastening parts 110 and the under body fastening parts 210, such that the upper body 100 and the under body 400 are coupled. Thereafter, the extension columns 320 are moved upward, and the jig 300 and the vehicle 500 are completely separated, such that the process of swapping the under body 400 is completed.

As described above, according to the example embodiment of the present disclosure, the process of lifting the upper body by using the magnets is applied to eliminate the fastening force between the upper body and the under body of the vehicle on the body swap station for an unmanned delivery vehicle, such that the process of swapping the under body may be quickly and conveniently performed.

In addition, it is possible to reduce noise and provide (e.g., ensure) durability (robustness) during the fastening process in comparison to a mechanically fastened upper body and under body.

In addition, it is possible to reduce the use of electric power by using (e.g., the principle of) magnetization and demagnetization made by the movement of the permanent magnet in comparison to using an electromagnet.

While the exemplary embodiments of the present disclosure have been described, the present disclosure is not limited to the example embodiments. The present disclosure covers (e.g., all) modifications that may be made from the example embodiments of the present disclosure.

What is claimed is:

1. A coupling structure for a vehicle, which comprises an under body comprising a drive module, and an upper body coupled to an upper end of the under body and comprising a space module, the coupling structure comprising:
an under body fastener provided in the under body and disposed to be coupled to the upper body by a magnetic force; and
an upper body fastener provided in the upper body and disposed to be coupled to or uncoupled from the under body fastener by applying or eliminating the magnetic force.

2. The coupling structure of claim 1, wherein:
the upper body fastener comprises:
an upper cover;
an upper magnet disposed below the upper cover;
a lower cover disposed below the upper magnet and coupled to the upper cover; and
a center magnet disposed below the upper magnet, configured to be moved to be inserted into or withdrawn from an inside of the lower cover, and having a hollow portion formed at a center thereof.

3. The coupling structure of claim 2, wherein:
the upper body fastener further comprises a spring provided on a lateral portion of the lower cover, provided at an end of the center magnet, and configured to provide an elastic force when the center magnet moves.

4. The coupling structure of claim 2, wherein:
the upper magnet comprises a plurality of bar magnets arranged in parallel in a longitudinal direction of the vehicle.

5. The coupling structure of claim 3, wherein:
a magnet column is inserted into the hollow portion of the center magnet from an outside of the lower cover, the magnet column provides the center magnet to be withdrawn outward from the inside of the lower cover, and the spring is compressed.

6. The coupling structure of claim 5, wherein:
when the magnet column is inserted into the hollow portion of the center magnet, an attractive force applied by a magnetic force is lost between the under body fastener and the upper body fastener.

7. The coupling structure of claim 5, wherein:
when the magnet column is withdrawn from the hollow portion of the center magnet, the center magnet is inserted into the lower cover by an elastic force of the spring, and an attractive force is applied between the under body fastener and the upper body fastener by a magnetic force.

8. The coupling structure of claim 2, wherein:
the under body fastener comprises a permanent magnet having a plate shape corresponding to a shape of a lower surface of the lower cover and coupled to the lower cover.

9. The coupling structure of claim 8, wherein:
a plurality of fastening protrusions are provided on the lower surface of the lower cover and protrude to an outside of the lower cover.

10. The coupling structure of claim 9, wherein:
a plurality of fastening grooves are provided in an upper surface of the under body fastener and coupled to the plurality of fastening protrusions.

11. The coupling structure of claim 5, wherein:
the under body fastener is a plurality of under body fasteners including four under body fasteners, wherein the four under body fasteners are provided at four corner portions of the under body, and
the upper body fastener is a plurality of upper body fasteners including four upper body fasteners, wherein the four upper body fasteners are provided at four corner portions of the upper body, and
four corner portions of the under body are positioned to correspond to four corner positions of the upper body, and
the magnet column is coupled to or uncoupled from the plurality of upper body fasteners by being moved by a jig disposed above the under body and the upper body.

12. The coupling structure of claim 11, wherein:
the jig comprises a pair of jig fixing parts, and extension columns extending from the jig fixing parts and configured to move in an upward direction and a downward direction.

13. The coupling structure of claim 12, wherein
the magnet columns are provided at lower ends of the extension columns.

14. The coupling structure of claim 13, wherein the magnet columns have shapes protruding toward the upper body fasteners.

15. The coupling structure of claim 12, wherein:
a jig fixing part of the pair of jig fixing parts is installed to be moved along a jig movement rail.

16. The coupling structure of claim 15, wherein the jig movement rail extends above the under body and the upper body.

17. The coupling structure of claim 12, wherein:
a distance measurement sensor is provided on a jig fixing part of the pair of jig fixing parts, and the distance measurement sensor is configured to measure a distance between the jig fixing part and a corner portion of the vehicle or a distance between the jig fixing part and a ground surface.

18. The coupling structure of claim 14, wherein:
at least one of the extension columns is moved downward to allow the magnet column to be inserted into the hollow portion of the center magnet, and a magnetic force between the under body fastener and the upper body fastener is eliminated.

19. The coupling structure of claim 18, wherein:
in a state in which the magnet column is inserted into the hollow portion of the center magnet, the extension column is moved upward, and a jig fixing part is moved along a jig movement rail, such that the upper body is moved to a location above a second charged under body.

20. The coupling structure of claim 19, wherein:
after the extension column is moved downward and the upper body is seated on the second charged under body, the jig fixing part is moved along the jig movement rail to allow the magnet column to be withdrawn from the hollow portion of the center magnet to complete a process of swapping the under body.
